(19) United States
(12) Patent Application Publication
(10) Pub. No.: US 2014/0181678 A1
(43) Pub. Date: Jun. 26, 2014

(54) INTERACTIVE AUGMENTED REALITY SYSTEM, DEVICES AND METHODS USING THE SAME

(71) Applicants: SIGAL LOUCHHEIM, El Dorado Hills, CA (US); JASON DAVIDSON, Granite Bay, CA (US)

(72) Inventors: SIGAL LOUCHHEIM, El Dorado Hills, CA (US); JASON DAVIDSON, Granite Bay, CA (US)

(21) Appl. No.: 13/722,357

(22) Filed: Dec. 20, 2012

(51) Int. Cl. G06F 3/048

(52) U.S. Cl. CPC G06F 3/048
USPC 715/738

(57) ABSTRACT

Interactive augmented reality devices, systems, and methods are described herein. In some embodiments, the devices, systems, and methods identify objects in an environment, and correlate at least one resource with said objects. An indicator signifying the correlation between said object(s) and said at least one resource may be produced using an interface of a device, such as a display. The indicator may be operable in response to a user action to initiate a control protocol that enables at least of modification and control of the resource with the device.

### FIELD

The present disclosure generally relates to interactive augmented reality technology, including devices, systems and methods. More particularly, the present disclosure relates to interactive augmented reality technology that may enable a user to interact with resources correlated or otherwise associated with objects identified by an augmented reality device.

### BACKGROUND

Individuals often find themselves in circumstances where they lack the information or resources needed to actively engage in conversations and/or participate in meetings. For example, meeting attendees may lack knowledge about the topic that is the subject of the meeting, who other meeting attendees are, etc. Without such knowledge, the attendee's ability to contribute to the meeting may be significantly diminished. While an attendee may utilize an electronic device to search for the information he needs, e.g., using a web browser, conducting such searches can occupy the attendee's attention and thus distract him from the meeting. As a result, electronic devices that may be designed to improve individual productivity may actually hinder productivity in certain situations, such as collaborative meetings.

For these and other reasons, meeting attendees are often asked to turn off their electronic devices during a meeting. In such instances, an attendee may choose to ask others for the information he needs to actively participate in the meeting. Such questions may distract other meeting attendees, and may unnecessarily extend the length of the meeting. This may annoy meeting attendees and generally reduce the effectiveness of the meeting.

Similarly, an individual may lack knowledge and or the capability to interact with and/or share resources that may be of interest to him in an efficient and/or desired manner. In the enterprise context, for example, an employee may lack knowledge that allows him to interact with a coworker and/or company resource at a desired time. For instance, an employee may wish to use a conference room, but may not know how to access and modify the conference room schedule to reserve the room. Similarly, an employee may wish to control audio visual resources during a meeting, but may not know how to do so. While the information required in either scenario could be determined by the employee by inputting a search on an electronic device, doing so may be time consuming and/or frustrating. Indeed, such searches may not provide a seamless experience wherein information and/or resources desired by an individual are obtained in a form that may be directly interacted with to achieve a desired goal.

### BRIEF DESCRIPTION OF THE DRAWINGS

Features and advantages of embodiments of the claimed subject matter will become apparent from the following detailed description and the drawings, wherein like numerals depict like parts, and in which:

FIG. 1 is a block diagram of an exemplary system architecture of an augmented reality system in accordance with the present disclosure.

FIG. 2 is a block diagram providing additional detail for an exemplary interactive augmented reality system in accordance with the present disclosure.

FIG. 3 is a block diagram of another exemplary augmented reality system in accordance with the present disclosure, wherein an interaction device communicated with a remote resource collection component.

FIG. 4 illustrates more detailed exemplary system architecture of an exemplary augmented reality system in accordance with the present disclosure.

FIG. 5 depicts an exemplary device platform for an interaction device consistent with the present disclosure.

FIG. 6 depicts an exemplary device platform for a remote device consistent with the present disclosure.

FIG. 7 depicts exemplary communication pathways between components of an exemplary augmented reality system in accordance with the present disclosure.

FIG. 8 is a flow diagram of an exemplary method in accordance with the present disclosure.

Although the following detailed description proceeds with reference made to illustrative embodiments, many alternatives, modifications, and variations thereof will be apparent to those skilled in the art.

### DETAILED DESCRIPTION

For the purpose of the present disclosure, the terms “component” and “components” mean computer related technology, namely software, hardware (e.g., circuitry), firmware, combinations thereof, and the like. For example, a component may comprise a processor, input output circuitry (e.g., a transceiver, a transponder, combinations thereof, and the like), one or more physical or environmental sensors such as a camera, a global positioning system (or other location determination system), a wireless network card, combinations thereof, and like. Alternatively or additionally, a component may comprise software and/or firmware executed by a processor. Components may be resident on (i.e., local to) a device, remote from a device, distributed/executed on multiple devices, or a combination thereof.

The terms “device” and “devices” are used herein to individually and collectively refer to any of the large number of electronic and non-electronic devices that may be leveraged as an “interaction device” and/or a “remote device,” as described herein. It is noted the terms “interaction device” and “remote device” are used for the sake of clarity and ease of understanding, e.g., to identify devices that may perform certain functions in certain instances. It should be understood that an interaction device may be capable of performing the functions of a remote device, and vice versa.

Non-limiting examples of devices that may be used in accordance with the present disclosure include automated teller machines, automobiles, automobile navigation systems, cell phones, chalk boards (electronic or otherwise), databases, desktop computers, displays (televisions, monitors, projection screens, digital signage, electronic whiteboards, and the like), electronic readers, facsimile machines, game consoles, internet access points (e.g., WIFI hot spots), internet devices, kiosks, lighting systems, netbook computers, notebook computers, payment terminals, personal digital assistants, media players and/or recorders, printers, public computer terminals, security cameras/systems, set-top boxes, smart phones, tablet personal computers, traffic cameras, ultra-mobile personal computers, wired telephones, wireless routers, combinations thereof, and the like. Such devices may be portable (e.g., mobile) or stationary. In some embodiments, the devices described herein are capable of communicating in a wired and/or wireless fashion, e.g., using one or more local area network protocols, wide area network protocols, close range communications network protocols, another communications protocol, combinations thereof, and the like.

As used herein, “close range communication” refers to systems and methods for wirelessly sending/receiving data signals between devices that are relatively close to one another. Close range communication includes, for example, communication between devices using a BLUETOOTH™ network, a personal area network (PAN), near field communication, ZigBee networks, combinations thereof, and the like. Close range communication may therefore be understood as direct communication between devices, without the need for intervening hardware/systems such as routers, cell towers, internet service providers, and the like.

“Long range communication” is used herein to refer to systems and methods for wirelessly sending/receiving data signals between devices that are a significant distance away from one another. Long range communication includes, for example, communication between devices using a WiFi network, a wide area network (WAN) (including but not limited to a cell phone network (3G, 4G, etc. and the like), the internet, a global positioning system (GPS), a combination thereof, and the like. Long range communication may therefore be understood as communication between devices that occurs with the use of intervening hardware/systems such as routers, cell towers, internet service providers, and the like.

The terms “direct communication” and “indirect communication” are used herein to denote communication between two devices that occurs directly or indirectly. In the former case (direct communication), communication signals may be sent between a first device (e.g., an inter action device) and a second device (e.g., a remote device) without the intervention of a third device. In the latter case (indirect communication), communication signals between a first device and a second device are routed through at least one third device (e.g., an enterprise server, a cloud (internet), a router, a switch, a wireless hotspot, a cellular repeater, combinations thereof, and the like).

From time to time, the present disclosure may describe one or more software components that may be utilized in association with the systems and methods described herein. In many instances, it is noted that such software components may take the form of a computer readable medium (e.g., a memory, a non-transient storage medium, etc.) having instructions stored thereon which when executed by a processor cause the processor to perform functions associated with the software component. While such implementation may or may not be preferred, it should be understood that the software components described herein may be implemented in any suitable manner. For example, such components may take the form of hard coded logic, a hardware process, one or more software modules, and the like.

The present disclosure generally relates to augmented reality devices, systems including the same, and methods utilizing the same. In some embodiments, the devices, systems and methods described herein may identify resources that may be of interest to a user, and permit a user to control or otherwise interact with such resources using an interaction device.

Broadly, the devices, systems and methods described herein can utilize one or more resource collection components (e.g., one or more local or remote sensors) to image an environment. Data obtained by the resource collection component(s) may be processed to determine the presence of objects in the environment and correlate one or more resource with such objects. One or more indicators signifying the presence of an object with a correlated resource may then be produced, e.g., on an interaction component such as a display of an interaction device. The indicator(s) may link or otherwise connect to the resource. For example, an indicator may be linked with a resource such that interaction with the indicator causes the execution of a control process that enables control and/or modification of the resource. In this way, the systems, methods and devices may provide a seamless interface through which a user may identify, control and/or interact with one or more identified resources.

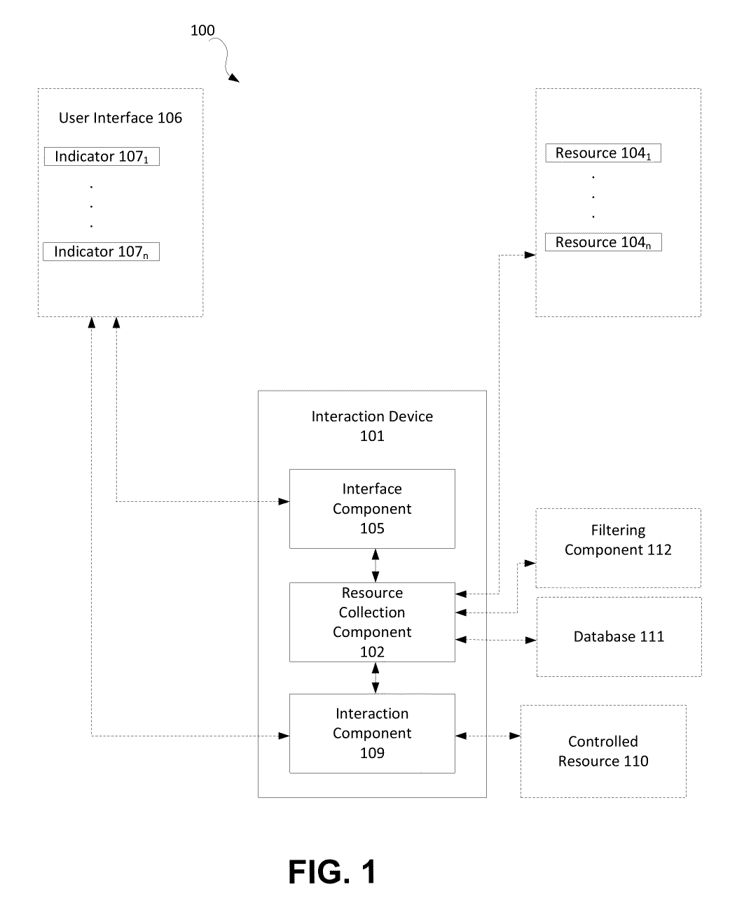

Reference is now made to FIG. 1, which is a block diagram of an exemplary augmented reality system consistent with the present disclosure. As shown, interactive augmented reality system 100 (hereinafter, “system 100”) includes interaction device 101. Interaction device 101 may be any type of device or combination of devices, as defined above. Without limitation, interaction device 101 is preferably a cell phone, smart phone, desktop personal computer, laptop personal computer, or tablet personal computer.

In this embodiment interaction device 101 includes resource collection component 102, interface component 105, and interaction component 109. Resource collection component 102 may function to obtain information about an environment or, more particularly, regarding objects and/or resources in an environment that may be of interest to a user of interaction device 101. Resource collection component 102 may obtain such information in any suitable manner. For example, resource collection component 102 may obtain such information by passively monitoring an environment, actively monitoring an environment, or a combination thereof.

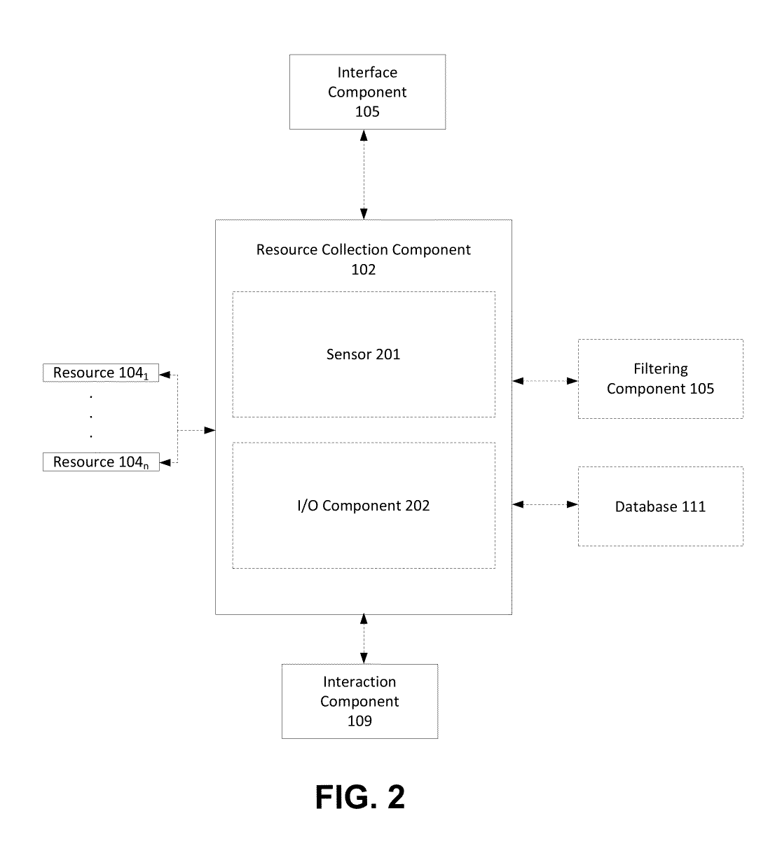

Resource collection component 102 may include one or more sensors 201 and/or one or more input/output (“I/O”) components 202, as shown in FIG. 2. Sensor 201 may be any type of sensor that is capable of detecting objects of interest to a user. For example, sensor 201 may be chosen from: optical sensors such as a stereo (2D) camera, a depth (3D) camera, combinations thereof and the like; optical detection and ranging systems such as a light imaging detection and ranging (LIDAR) system; radio frequency detection and ranging (RADAR) detectors; infrared sensors; photodiode sensors; audio sensors; location sensors such as a global positioning system (GPS); other types of sensors, combinations thereof, and the like. In some non-limiting embodiments, sensor 201 is chosen from a stereo camera, depth camera, GPS, combinations thereof, and the like.

I/O component 202 may be any type of component that is that is capable of sending and receiving information with interaction device 101. For example, I/O component 202 may include an antenna, a transmitter, a receiver, a transceiver, a transponder, a network interface device (e.g., a network interface card), combinations thereof, and the like. Such components may be capable sending and/or receiving data signals using one or more wired or wireless communications protocols. In some embodiments, I/O component 202 may be capable of detecting objects and available resources in an environment using one or more wired and/or wireless communications technologies, such as BLUETOOTH™, near field communication (NFC), a wireless network, a cellular phone network, combinations thereof, and the like. For example, I/O components may detect the present of objects and/or resources in an environment by monitoring for signals from one more transponders, transmitters, beacons or other communications devices within I/O component 202's communications range.

In any case, resource collection component 102 may be capable of imaging an environment within its field of view/detection range. As used herein, the terms, “image” and “imaging” when used in the context of the operation of a resource collection component mean that data is gathered by the component about an environment that is local to or remote from interaction device 101. Accordingly, the present disclosure envisions resource collection components that image an environment by recording and/or monitoring some portion of the electromagnetic spectrum. For example, resource collection component 102 may be configured to record and/or monitor the infrared, visual, and/or ultraviolet spectrum within its field of view. Alternatively or additionally, resource collection component 102 may image objects in an environment by monitoring and/or recording auditory signals, data signals, location (e.g., GPS) signals, combinations thereof, and the like. In the exemplary embodiment shown in FIGS. 1 and 2, resource collection component 102 may image objects (not shown) containing resources 104₁, 104ₙ (n being an integer greater than 1) within an environment that is local or remote to interaction device 101.

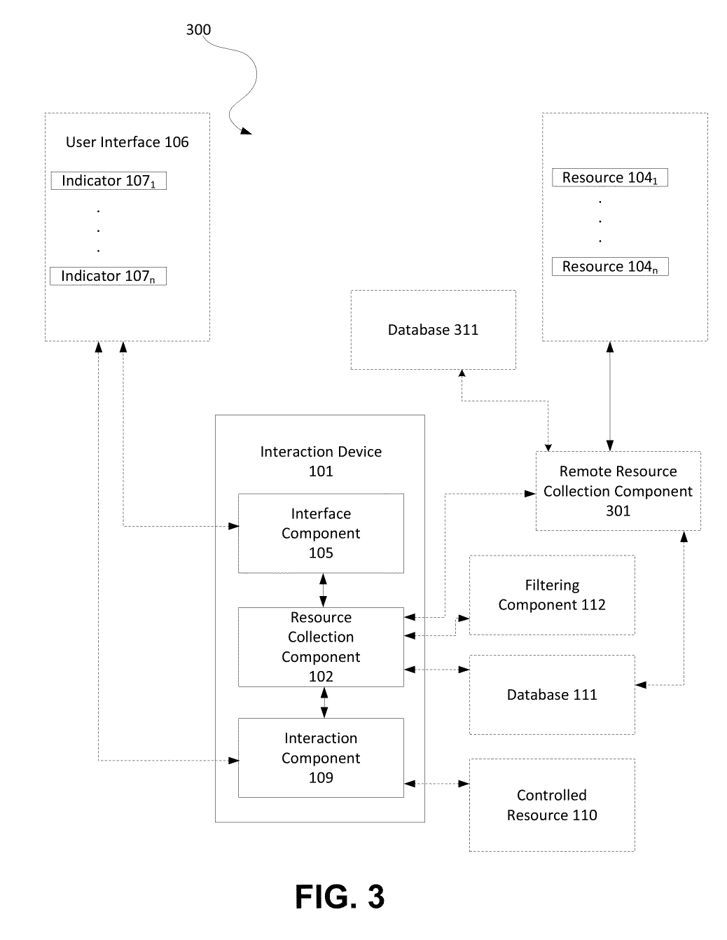

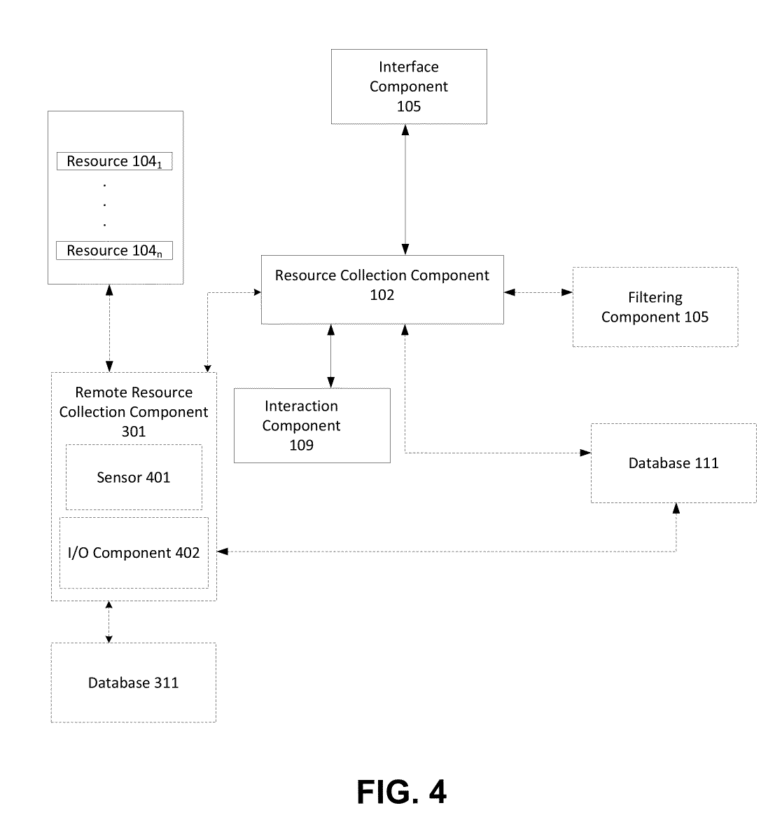

In FIGS. 1 and 2, system 101 includes a single resource collection component 102 that is local to interaction device 101. It should be understood that this illustration is exemplary, that any number of resource collection components may be used, and that each resource collection component may include any suitable number of sensors and/or I/O components. It should also be understood that resource collection components need not be local to interaction device 101. Indeed, interaction device 101 may receive data about an environment from one or more remote resource collection components, as will be described later in connection with FIGS. 3 and 4. Resource collection component 102 may also receive information regarding an environment and/or resources available therein from a local or remote database, as will also be described later.

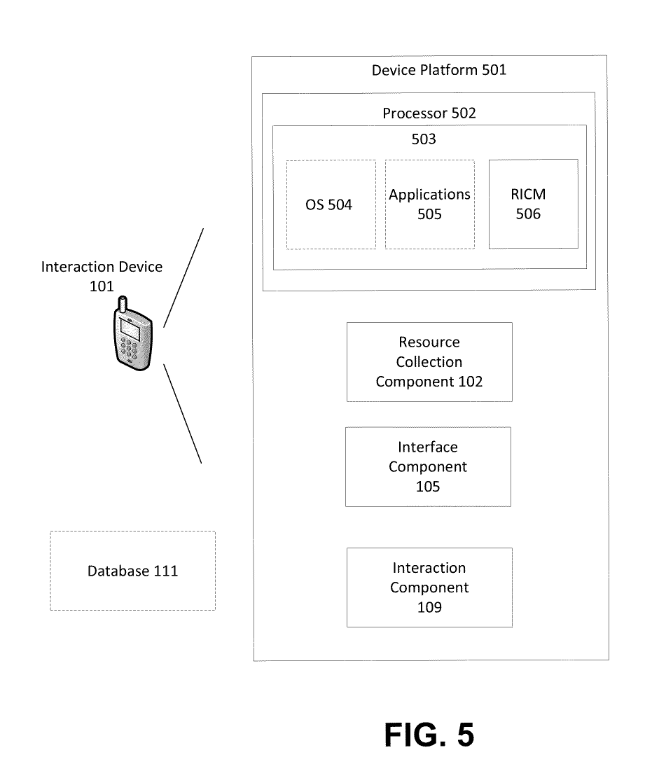

Returning to FIG. 1, as noted previously resource collection component 102 may function to image an environment, e.g., by scanning an environment using one or more sensors, monitoring data signals received by an I/O device, combinations thereof, or the like. Regardless of how an environment is imaged, resource collection component 102 may output an environmental data signal (not shown) to a processor (not shown) for analysis. The processor may be local to interaction device 101 (e.g., processor 502 in FIG. 5), or remote (e.g., a processor on a remote device, a network server, combinations thereof, or the like). In any case, the processor may be configured to analyze the resource collection signal and determine the presence (or absence) of objects and associated resources in the imaged environment.

The type of analysis performed by the processor may depend on the nature of the data conveyed by the environmental data signal. In instances where the environmental data signal contains still and/or video images for example, a processor may utilize depth segmentation, image recognition, machine learning methods for object recognition, other techniques, and combinations thereof to determine the presence of objects within the imaged environment. In circumstances where an environmental data signal contains auditory information, a processor may utilize sound source localization, machine learning classification, the Doppler effect, other techniques, and combinations thereof to determine the presence of objects in the imaged environment. In this way, resource collection component may determine the presence and/or nature of objects in an imaged environment.

Of course, it is not always necessary for a processor to perform the foregoing analysis to determine the presence of objects within an environment. Indeed as noted previously, resource collection component 102 may include I/O component 202, which may be configured to obtain information about an environment from one or more local or remote sources. In instances where resource collection component 102 includes a location sensor such as a GPS sensor, for example, such GPS sensor may be used to determine the location of interaction device 101. Resource collection component 102 may use such location information to identify objects in an environment, e.g., by querying a database such as database 111 in FIG. 1 using I/O component 202. Database 111 may correlate items imaged by device 101 (or a remote resource collection component) to relevant resources.

By way of example, database 111 may be a database stored in a memory (not shown) of interaction device 101, and may include a list of items and associated resources. Such resources may be indexed in any suitable manner, e.g., by location, room number, etc. In some instances, database 111 may be pre-loaded prior to the imaging of an environment, e.g., on interaction device 101 or another location. Regardless of whether database 111 is pre-loaded, it may be further populated and/or updated by communicating with one or more interaction devices, a central server, a database administrator, combinations thereof, and the like.

In some embodiments, database 111 may correlate objects imaged by interaction device 101 to resources that are local to or remote from interaction device 101. For example, database 111 may include a database of objects and/or resources indexed by a characteristic, such as location, name, company, room number, combinations thereof, and the like. Database 111 may, in response to a query signal from resource collection component 102 containing the characteristic, transmit or otherwise convey object/resource information associated with the characteristic to interaction device 101. Alternatively or additionally, database 111 may index objects and resources by GPS coordinates. In such instances, database 111 may, in response to the a query signal from resource collection component 102 containing GPS coordinates, transmit or otherwise convey object/resource information (if any) associated with such coordinates to interaction device 101.

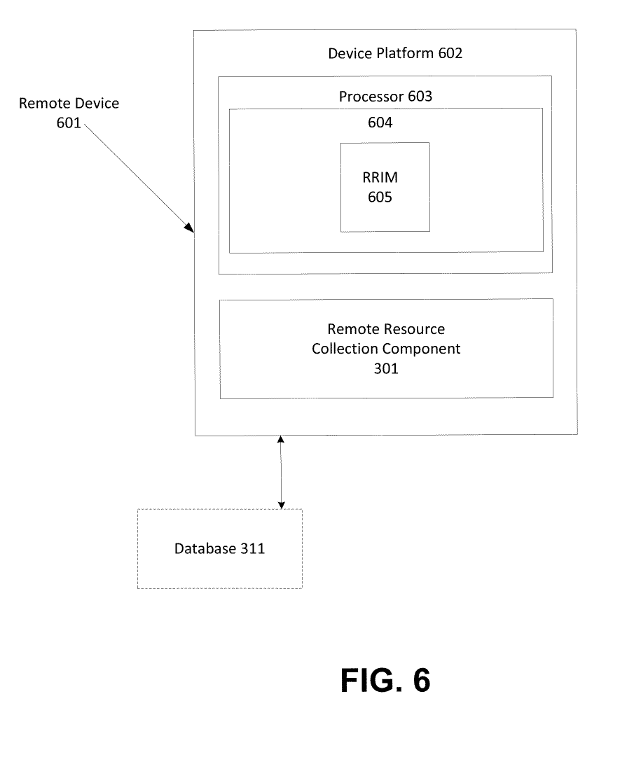

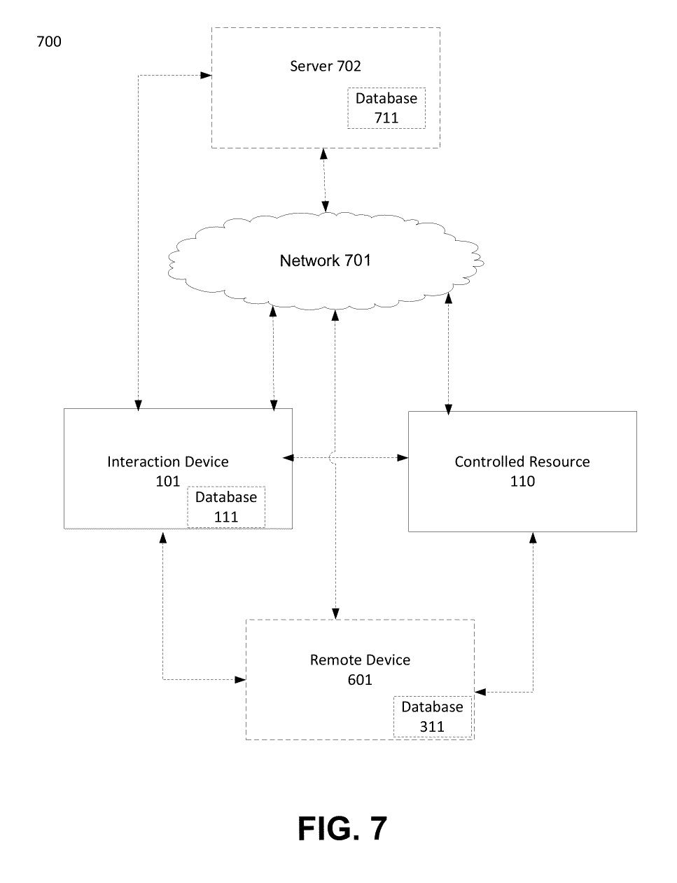

For the sake of illustration many of the FIGS. illustrate database 111 as being separate from interaction device 101. It should be understood that such a configuration is exemplary, and that database 111 (if used) may be present at any suitable location. For example, database 111 may be local or remote to interaction device 101. In the former case (local storage), database 111 may be stored in a memory of interaction device 101. In the latter case (remote storage), database 111 may be stored on a remote device (e.g., database 311 in FIGS. 3, 4 and 7), a enterprise/cloud/internet server (e.g., database 711 in server 702 of FIG. 7), a beacon, a transponder, another device, combinations thereof, and the like. This concept is depicted in FIGS. 1-4 by the hashed lines surrounding database 111, which illustrate both its optional nature and flexible location. In some embodiments, database 111 is locally stored on interaction device 101, e.g., in a memory thereof. In other embodiments, database 111 is stored remotely from interaction device 101, e.g., on a remote resource collection device, a network server, combinations thereof, and the like. Of course, a local copy of database 111 may be maintained on interaction device 101, and a remote copy of database 111 or a corresponding database (e.g., database 311 and 711 in FIGS. 6 and 7) may be maintained on a remote device and/or server.

Regardless of how objects in an environment are imaged and identified, resource collection component 102 may function to identify and correlate resources with such objects. As used herein, “correlate resources” means that a resource collection component or another component identifies and/or associates a resource with an object in an environment. As may be appreciated, the type and nature of such resources may vary widely. Non limiting examples of such resources include use and/or repair instructions, background and/or information relevant to the item, audio/visual resources available with or through an object, computing resources available with or through the object, communications systems available with or through the object and which may be used to transmit and/or receive information, e-commerce systems (e.g., where the object may be purchased), enterprise systems, databases, and/or documents relevant to an object (e.g., email systems, scheduling systems, telecommunication systems, computing networks, and the like), combinations thereof, and the like. Further non-limiting examples of suitable resources include audio and/or visual resources such as displays (e.g., television displays, computer monitors, electronic whiteboards, projectors, etc.), audio systems (e.g., speakers, public address systems, microphones, etc.), lighting (e.g., overhead lighting, component lighting, etc.), computing resources (e.g., processors, graphical processing units, network processing units, mass storage, information databases, etc.), electronic scheduling resources (e.g., electronic calendars, reservation systems, docketing systems, etc.). Of course, such examples are non-limiting, and other resource types are envisioned herein and are suitable for use in the present disclosure.

The type and nature of such resources may depend on the objects detected by interaction device 101 (or a remote resource collection component). For example, resources associated with detected textual information (e.g., in print or electronic media) may include an electronic dictionary and/or thesaurus that can provide information about the text, e.g., the definition of a word, the meaning of an acronym, information regarding projects and/or products related to detected words, resources associated with the text (equipment, human resources, office resources, and the like), combinations thereof, and the like. In the case of detected objects, resources may include information about the object (e.g., its identity, location, history, authorized users, etc.), its capabilities, reservation/scheduling information/systems, combinations thereof, and the like.

Correlation of resources associated with objects in an environment may occur in any suitable manner. In some embodiments, resource collection component 102 correlates resources with objects in an environment by querying a local or remote database, such as databases 111. In such instances, database 111 may include a database of objects and associated resources, which may be indexed by object type, make, and/or model, location, and combinations thereof and the like. Alternatively or additionally, interaction device 101 may determine resources associated with objects from signals received from such objects and/or a remote device (e.g., a transponder). In some embodiments for example, an object identified by resource collection component 102 may be capable of wired or wireless communication and may continuously, variably, and/or periodically broadcast a signal identifying its resources. Alternatively or additionally, a remote device with knowledge of objects and/or resources in an environment may continuously, periodically, or variably broadcast a signal identifying such objects and/or resources. In either case, interaction device 101 may receive such signals (e.g., using I/O component 202) and process them to determine objects and/or resources in an environment.

In other embodiments, interaction device 101 may attempt to communicate with an object using a wired or wireless protocol to determine what resources are associated with that object. For example, where an object is capable of wired or wireless communication, interaction device 101 may send a query signal to the object. In response to the query signal, the object may emit a resource identification signal that identifies its resources. Interaction device 101 may receive the resource identification signal (e.g., using I/O component 102) and process it to determine resources associated with such object.

As one example illustrating how interaction device 101 may correlate resources with detected objects, interaction device 101 may be used in an office environment to image a conference room sign with sensor 201 (e.g., a camera) of resource collection component 102. In such instance, sensor 201 may send an environmental data signal containing an image of the sign to a processor of interaction device 101 (e.g., processor 502 of FIG. 5). The processor may use one or more object recognition and/or optical character recognition techniques to recognize the text of the sign. The processor may then determine resources associated with the text of the sign, e.g., by querying one or more systems and/or databases (not shown) for “hits” correlating to the text. Such databases/systems may be stored locally and/or remotely from interaction device 101, as described previously.

For the sake of this example, interaction device 101 may store database 111, which includes a database of textual terms, acronyms, project titles, object titles, combinations thereof, and the like, each of which are associated with pertinent information (e.g., definitions, project information, object capabilities, object interface information, combinations thereof, and the like). To determine resources associated with the text of the sign, the processor may query database 111 for hits correlating to the detected text. If a hit is found, the processor may correlate database 111 to the imaged text.

In some embodiments, resource collection component 102 may identify and correlate resources with objects in an environment by analyzing one or more signals received from a remote resource collection component. This concept is illustrated in FIGS. 3 and 4, wherein remote resource collection component 301 is configured to provide information about objects in an environment to resource collection component 102. In some embodiments, remote resource collection component 301 is included in one or more devices (as defined above) that are remote from interaction device 101 (hereinafter, “remote devices”). Without limitation, the remote devices described herein are preferably chosen from cell phones, smart phones, desktop personal computers, laptop personal computers, tablet personal computers, transponders, wireless network beacons, combinations thereof, and the like.

Regardless of its nature and where it is provisioned, a remote resource collection component may include at least one sensor and and/or at least one I/O component. This concept is illustrated in FIG. 4, wherein remote resource collection component 301 includes at least one sensor 401 and/or at least one I/O component 402. The nature and operation of sensor 401 and I/O component 402 is analogous to the nature and operation of sensor 201 and I/O component 202, and thus is not reiterated here.

In some embodiments, remote resource collection component 301 may image an environment on behalf of resource collection component 102 and transmit environmental data signals containing information about such environment to interaction device 101. Accordingly, remote resource collection component 301 may be in wired and/or wireless communication with interaction device 101. Environmental data signals transmitted by remote resource collection component 301 may include for example raw data which may be subsequently processed by interaction device 101 to identify objects and/or resources imaged by remote resource collection device 301. Non-limiting examples of such raw data include raw image data, audio data, video data, signal data (e.g., signals received by remote resource collection device 301 regarding objects and/or resources), and combinations thereof.

Alternatively or additionally, remote resource collection component 301 may itself include a processor (not shown), which may analyze raw data obtained by imaging an environment with sensor 401 and/or I/O component 402 to identify objects and/or resources in such environment. In such instance, remote resource collection component 301 may transmit environmental data signals identifying objects and resources detected in the imaged environment to interaction device 101.

To the extent a remote device includes its own resources (i.e., resources local to the remote device), remote resource collection component 301 may report such resources to interaction device 101 in the same manner described above with respect to objects and resources external to such remote device and/or remote resource collection component 301. For example, where a remote device includes audio and/or visual resources, remote resource collection component 301 may detect and report such resources to interaction device 101.

For the sake of clarity and ease of understanding, FIGS. 3 and 4 are illustrated as including a single remote resource collection component 301. It should be understood that such a configuration is exemplary, and that any suitable number of remote resource collection components may be used. Indeed, the present disclosure envisions embodiments wherein greater than 1 remote resource collection component is used, such as about 2, about 5, about 10, about 15, about 20, about 50, about 100, about 500, about 1000, about 10,000, or more remote resource collection components are used. In instances where a plurality of resource collection components is used, such plurality may be referred to as a “sensor network.” Such a sensor network may include sensors within resource collection component 102 and remote resource collection component(s) 301. Alternatively or additionally, a sensor network may include a plurality of remote resource collection components 301 (i.e., without sensor 201 of resource collection component 102).

Resource collection components within a sensor network may operate individually or collectively, and may be in wired or wireless communication with one another. Such communication may be direct or indirect between components, and may occur via short and/or long range communication. In some embodiments, environmental signals from one or more resource collection components in a sensor network may be transmitted directly to resource collection component 102. Alternatively or additionally, environmental signals from one or more resource collection components in a sensor network may be transmitted indirectly to resource collection component 102. For example, a first remote resource collection component may transmit environmental signals to at least one second remote resource collection component, which may forward such signal and/or transmit a new signal to resource collection component 102. The second remote resource collection component may therefore act as a pass through or “bridge” between the first remote resource collection component and resource collection component 102.

Like resource collection component 102, remote resource collection component 301 need not image an environment with sensor 401 and/or I/O component 402. For example, resource collection component 301 may include or be in communication with database 311, which may be local to or remote from remote resource collection component 301. Database 311 may contain a database of objects and associated resources that are relevant to remote resource collection component 301 and/or its environment. For example, remote resource collection component may be a beacon, a transponder or other communications device within an environment (e.g., a room) of interest to a user of interaction device 101. In such instance, database 311 may include a list of objects and resource within the environment in which remote resource collection component 301 is disposed. Independently or in response to a signal from interaction device 101, remote resource collection component 301 may query database 311 for objects and resources in its environment, and broadcast an environmental data signal containing such information to interaction device 101. In this way, remote resource collection component 301 can identify objects and/or associated resources, and transmit such information to interaction device 101.

Where present, remote resource collection component 301 may communicate with database 111 regarding objects and resources in its environment. For example, remote resource collection component 301 may query database 111 with a signal containing a characteristic of remote resource collection component 301, such as its location or another identifier. Database 111 may respond to such a query by sending a response signal identifying objects and/or resources in an environment relevant to remote resource collection component 301. Such response signal may be sent to remote resource collection component, to interaction device 101 (e.g., to resource collection component 102), or a combination thereof. This concept is illustrated in FIG. 3 by the hashed lines between database 111, resource collection component 102, and remote resource collection component 301.

For the sake of illustration, database 311 is illustrated in various FIGS. as a component that is separate from remote resource collection component 301. It should be understood that database 311 may be local to or remote from remote resource collection component 301 and/or a remote device containing remote resource collection component 301 (e.g., remote device 601 in FIG. 6). This concept is depicted in various FIGS. by the hashed lines surrounding database 311, which illustrate both its optional nature and variable location. In some embodiments, database 311 is stored locally in a memory (not shown) of remote resource collection component 301 and/or a memory of a remote device containing remote resource collection component 301. In other embodiments, database 311 is stored remotely from remote resource collection component 301, e.g., on another remote device, enterprise network server, a cloud (e.g., internet) server, combinations thereof, and the like.

The resource collection components described herein may also function to provide object and resource information to an interface component of an interaction device. In the embodiment of FIG. 1 for example, resource collection component 102 may output an environmental signal to interface component 105 that includes information regarding one or more detected objects, and one or more resources associated with such detected object(s). For example, resource collection component 102 (e.g., a processor thereof) may output an environmental signal (not shown) to interface component 105 (e.g., a processor thereof), e.g., using I/O component 202. Such environmental signal may include information about the objects detected by resource collection component 102 and/or resources correlated with such objects. Resource collection component 102 may therefore be in wired and/or wireless communication with interface component 105. Regardless of the mode of communication, the environmental signal (s) may be one or more analog and/or digital signals that convey information about the objects detected by resource collection component 102 to interface component 105.

Interface component 105 is generally operable to analyze signals from resource collection component 102 and cause one or more indicators to be produced on interaction component 109 (e.g., a display) of interaction device 101. Accordingly, interface component 105 may include user interface circuitry (not shown) configured for this purpose. “Circuitry,” as used in any embodiment herein may comprise for example, singly or in any combination, hardwired circuitry, programmable circuitry, state machine circuitry, and/or firmware that stores instructions executed by programmable circuitry. Interface component 105 may therefore include user interface circuitry that is integral to or separate from a processor of interaction device 101 (e.g., processor 502 of FIG. 5). Thus for example, interface component 105 may take the form of a graphics processing unit, a video display chip, an application specific integrated circuit, combinations thereof, and the like. Alternatively or additionally, interface component may leverage processing resources of processor 502 to analyze signals received from resource collection component 102.

While FIG. 1 depicts interface component 105 and resource collection component 102 as separate components (e.g., a separate from a processor of interaction device 101), such configuration is not required. Indeed in some embodiments, all or a portion of interface component 105 and resource collection component 102 are integral with a processor of interaction device 101. In such instances, such processor may detect objects and associated resources (as described above) and output an environmental signal to a portion of the processor that is responsible for outputting an audio and/or video signal. Accordingly, a processor of interaction device 101 (e.g., processor 502 of FIG. 5) may be capable of performing general computing tasks, as well as audio and/or video tasks. Non-limiting examples of such processors include certain models of the Ivy Bridge line of processors produced by INTEL™ Corporation. Of course, other processors may also be used.

In some embodiments, interface component 105 (e.g., a processor thereof) is configured to process environmental signals received from resource collection component 102 and to output an interface signal that causes one or more indicators to be produced on interface component 109 of interaction device 101. This concept is illustrated in FIGS. 1 and 3, which depict interface component 105 as producing indicators 107₁, 107ₙ within a user interface 106 on interaction component 109 of interaction device 101. In some embodiments, interaction component 109 is chosen from a display, a touch screen, a lighting element, a button, another audio and/or visual component, combinations thereof, and the like. Without limitation, interaction component 109 is preferably a display such as a touch screen. Regardless of the nature of interaction component 109, the production of indicators 107₁, 107ₙ may alert a user of interaction device 101 to the presence of an object that includes one or more resources with which the user may wish to interact.

Indicators consistent with the present disclosure may take any suitable form and may include visible and non-visible (e.g., auditory/tactile, etc.) indicators. In some embodiments, the indicators described herein take the form of readable symbols, such as dots, x's, zeros, triangles icons, numbers, letters, text (e.g., words) combinations thereof, and the like. Of course, indicators in the form of readable symbols are not required. Indeed in some embodiments, indicators 107₁, 107ₙ take the form of arbitrary symbols, white noise, fractal images, random and/or semi-random flashes, object outlines, combinations thereof, and the like. Without limitation, the indicators described herein are preferably in the form of object outlines and/or text.

In some embodiments the indicators described herein may be overlaid or integrated with one or more images of items of interest that are displayed on interaction component 109 of interaction device 101. For example, interaction component 101 may display a real world image of the environment surrounding interaction device 101, including objects and corresponding resources. In such instances, indicators may trace, overlie, or otherwise associate with objects of interest depicted in the real world image. In some embodiments, the indicators are configured in the form of a “halo” or outline around an object of interest that is depicted on a display of interaction device 101. In still further embodiments, the indicators described herein may include one or more hardware components. For example, interaction device 101 may include one or more lights (not shown), which may be toggled on and off to indicate the presence of an item of interest and the availability of associated resources.

Although indicators consistent with the present disclosure may or may not be readable by a user, they may nonetheless perform the function of alerting a user of interaction device 101 to the presence of a detected object and associated resources. Indeed, a user that perceives such an indicator may understand the indicator to signify the availability of resources with which the user may wish to interact. This may prompt the user to interact with the indicator. Such interaction may include for example clicking on the indicator with a virtual pointer (e.g., a mouse cursor), touching the indicator (e.g., in instances where interaction device 101 includes a touch sensitive display), combinations thereof, and the like. In addition to this functionality, indicators consistent with the present disclosure may convey additional information about a detected object to a user. For example, indicators produced on interaction component 109 (e.g., a display) may represent the type and/or number of resources, their proximity to interaction device 101, the security level of such resources, combinations thereof, and the like.

In addition to producing indicators signifying the presence of resources, the interface components described herein may link or otherwise associate an indicator to resources correlated a detected object. For example interface component 105 of FIG. 1 may link indicator 107₁ with an object that includes resource 104₁, indicator 107ₙ with an object that includes resource 104ₙ, and so on. As will be described later, the indicators described herein may be linked to resources correlated with detected objects such that interaction with an indicator initiates one or more control protocols to enable control and/or modification of such objects and/or resources.

In the embodiment of FIG. 1 for example, resource collection component 102 may image an environment and detect objects (not shown) that include resource 104₁ and 104ₙ respectively. Resource collection component 102 may output a signal identifying those objects and resources 104₁, 104ₙ to interface component 105. In response to receiving such signal, interface component 105 may cause the production of relevant indicators on interaction component 109. For example, interface 105 may cause the production of indicators 107₁ and 107ₙ within user interface 106 of interaction component 109. Indicators 107₁ and 107ₙ may be linked to resources 104₁ and 104ₙ respectively, and may be configured to initiate the execution of a control protocol that enables control and/or modification of the resource 104₁ and 104ₙ respectively. In some embodiments, interaction with indicator 107₁ may cause interaction device 101 to communicate with resource 104₁ so as to establish control thereof. This is concept is illustrated in various FIGS. by the depiction of controlled resource 110, which correlates to one or more of resource 104₁ and 104ₙ.

As described previously, resource collection component 102 may receive information regarding an imaged environment from a remote resource collection component. In such instances, resource collection component 102 may function to analyze and/or forward such information to interface component 105 for the production of relevant indicators. In the embodiment of FIG. 3 for example, remote resource collection component 301 may image an environment and detect objects (not shown) containing resources 104₁ and 104ₙ. Remote resource collection component may transmit an environmental signal containing information regarding the imaged environment to interaction device 101, e.g., I/O component 202 of resource collection component 102. Such communication may be direct (i.e., between interaction device 101 and remote resource component) or indirect (e.g., through a third party device such as a network server, another device, combinations thereof, and the like, not shown), and may occur using close range or long range communication.

Regardless of the mode of communication, resource collection component 102 may process an environmental signal from remote resource collection component 301 and correlate resources 104₁ and 104ₙ to corresponding objects in the imaged environment. Resource collection component 102 may then output a signal identifying those objects and resources 104₁/104ₙ to interface component 105. In response to receiving such signal, interface component 105 may cause the production of relevant indicators on interaction component 109. For example, interface 105 may cause the production of indicators 107₁ and 107ₙ within user interface 106 of interaction component 109. Indicators 107₁ and 107ₙ may be linked to resources 104₁ and 104ₙ respectively. Indicators 107₁ and 107ₙ may be configured to initiate the execution of a control protocol that enables control and/or modification of the resource 104₁ and 104ₙ respectively, as previously described. For example, interaction with indicator 107₁ may cause interaction device 101 to communicate with resource 104₁ so as to establish an ability to modify and/or control resource 104₁ via interaction device 101. This is concept is illustrated in FIG. 3 by the depiction of controlled resource 110, which correlates to one or more of resource 104₁ and 104ₙ.

Communication between interaction device 101 and controlled resource 110 may occur via any suitable means, including close range communication, long range communication, and combinations thereof. Such communication may be direct or indirect, as previously defined. In any case, communication between interaction device 101 and controlled resource 110 may occur using a predefined communications protocol.

As may be appreciated, the systems, devices, and methods a described herein may enable the rapid identification of objects and associated resources, and the production of corresponding indicators on an interface of an interaction device. While the unfiltered production of such indicators may be useful, it may be beneficial to limit the display of indicators in a desired manner. This may be particularly true in settings where the devices, systems and methods of the present disclosure may identify a plurality of objects and or resource in an environment, which may result in the production of a correspondingly large number of indicators on an interaction component (e.g., display) of an interaction device. In such instances, it may be desirable to filter the objects and resources identified by a resource collection component such that indicators are produced only for objects and resources that are likely to be of interest to a user of an interaction device. In other words, it may be desirable to ignore certain objects and/or resources identified by a resource collection component, while displaying indicators for other objects and/or resources that may be of interest to a user.

Accordingly, the interaction devices described herein may include one or more filtering components. This concept is illustrated in FIGS. 1 and 3, wherein systems 100, 300 optionally include filtering component 112. Filtering component 112 may be stored locally on interaction device 101, or in a remote location such as a remote device, an enterprise network server, a cloud server, combinations thereof, and the like. Without limitation, filtering component is preferably stored in an online/cloud environment, such as a network or cloud server. In such instance, interaction device 101 may communicate with the remote filtering component to obtain appropriate filtering information prior to producing indicators on an interaction component (e.g., display). Of course, filtering component 112 may be resident on interaction device 101, e.g., in an offline instantiation. In such instances, filtering component 112 may sync with an online (cloud-based) filtering component when interaction device 101 may establish a data connection with such online filtering component.

Regardless of its location, filtering component may function to filter the objects and resources identified by resource collection component 102 (or a remote resource collection component) such that interface component 105 produces indicators for objects and resources that are likely to be of interest to a user of interaction device 101. Accordingly, filtering component 112 may include a user profile (not shown) containing information regarding a user of interaction device 101 (hereinafter, “user information”). Examples of such user information include but are not limited to the user's gender, age, educational level, physical and/or mental handicaps, a profile of the user's occupation (“occupational profile”), a profile of the user's personal life (“personal profile”), the user's shopping habits, social network information, information regarding the user's geographical movements and/or location, combinations thereof, and the like. Alternatively or additionally, the personal profile may include user preferences regarding the manner in which indicators are presented by interaction device 101. For example, a user may specify the type of objects/resources they wish to be notified of, what type of indicators (audio, visual, tactile, etc.) they prefer, combinations thereof, and the like.

Interaction device 101 (or more particularly, a processor thereof) may apply information in the user profile to cause interface device to omit or produce indicators for detected objects and/or resources based on the needs, desires, and/or interests of a user. For example, based on information in the user profile, interaction device 101 may analyze object detection and resource identification signals produced by resource collection component 102, and cause interface device 105 to limit the display of indicators accordingly.

Filtering component 112 may also include information regarding the security and/or access level of a user of interaction device 101 (hereinafter, “security information”). In the enterprise context for example different individuals may have access to different company resources, or may access the same resources to different degrees. Filtering component 112 may account for this difference by including security information that reflects the appropriate access level of a user. Such security information may therefore be used to prevent interface component 105 from displaying indicators for objects/resources that a user of device 101 does not have clearance/authorization to access. Alternatively or additionally, such information may be utilized in an authentication protocol executed between interaction device 101 and a resource to be modified/controlled—thus preventing unauthorized access to resources when a user is not cleared/authorized to access such resource.

Filtering component 112 may also include contextual factors and/or alerts that may impact the manner in which indicators are produced by interaction device 101. Non-limiting examples of such contextual factors and alerts include the location of interaction device 101, entries in an electronic schedule, the presence of other interaction devices and/or remote devices, the time of day, biometric information regarding a user of interaction device 101, combinations thereof and the like. Interaction device 101 may control the nature and type of indicators produced by interface component 105 based on such contextual factors. In instances where contextual factors indicate that a user is in a business meeting, filtering component 112 may be applied by interaction device 101 to cause interface device 105 to limit the display of indicators to those corresponding to resources that are relevant to the meeting. For example, interface component 105 in such instances may produce indicators in association with objects and resources that are relevant to the meeting, while omitting the display of indicators in association with irrelevant objects/resources.

Information in filtering component 112 may be entered by a user of device 101 or by some other mechanism. For example, interaction device 101 may determine information for inclusion in filtering component 112 based on information it detects, e.g., using resource collection component 102, second 201, or another component. In some embodiments, interaction device 101 may its usage overtime, and extrapolate such usage into information that may be utilized in filtering element 112. For example, interaction device 101 may record its GPS coordinates and thus, the geographical location of a user. Interaction device 101 may use such location information as information in filtering component 112, so as to limit the production of indicators to those relevant to device 101's location.

Interaction device 101 may also record information regarding the objects and/or resources with which it is used to interact. For example, a user may utilize of interaction device 101 to frequently interact with a particular type of device (i.e., a “high use device”), such as a company computer resource. Based on such usage, interaction device 101 may include information regarding high use devices in filtering component 112. In this way, such information may be used to limit the display of or preferentially display indicators relating to high use devices, either alone or in combination with filtering indicators relating to other objects/resources.

Interaction device 101 may also use contextual factors and/or alerts to filter detected objects and/or resources. For example, interaction device 101 may be aware of its location, its user's schedule, the presence of other interaction devices, or a combination thereof. Based on such information, interaction device may limit or emphasize the display of indicators relating to certain detected objects and/or resources. Likewise, interaction device may apply alert information (e.g., a security lockdown or other broadcast information) to limit or emphasize the display of indicators relating to certain detected objects and/or resources.

Reference is now made to FIG. 5, which depicts a block diagram of an exemplary system architecture of an interaction device 101 consistent with the present disclosure. As shown, device 101 includes device platform 501. For the sake of illustration only, device 101 is depicted in FIG. 5 as a smart phone and thus, device platform 501 may correlate to a smart phone platform. However, it should be understood that device 101 and device platform 501 may take another form. As non-limiting examples of device platforms that may be used as device platform 501, mention is made of platforms associated with the devices mentioned above. Without limitation, device platform 501 is preferably a cell phone platform, smart phone platform, notebook computer platform, desktop computer platform, a netbook platform, a tablet personal computer platform, or combinations thereof.

Device platform 501 includes at least one host processor 502. Host processor 502 may be configured to execute software 503, including but not limited to operating system (OS) 504, and applications 505. In addition, software 503 may include resource identification and collection (RICM) module 506. Device platform 501 further includes sensor resource collection component 102, interface component 105, and interaction component. The nature and function of resource collection component 102, interface component 105, and interaction component 109 are as previously described in connection with FIGS. 1-4, and thus are not reiterated herein.

Generally, RICM 506 is in the form of computer readable instructions that may be stored within a memory (not shown) of interaction device 101. For example, RICM 506 may be stored on memory that is local to processor 502, and/or in another memory such as a memory within user interface circuitry or other circuitry. Such memory may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, such memory may include other and/or later-developed types of computer-readable memory.

It should therefore be understood RICM 506 may be in the form of instructions stored in a computer readable medium, which when executed may cause processor 502 to perform operations consistent with the present disclosure. For example, RICM 506 when executed may cause interaction device 101 (or, more particularly, processor 502) to perform resource detection/collection operations, interface operation, and interaction operations consistent with the present disclosure. Such operations are consistent with the functions of resource collection component 102, interaction component 105, and interaction component 109 discussed above. Accordingly, the description of such operations is not reiterated here.

Reference is now made to FIG. 6, which depicts a block diagram of an exemplary system architecture of a remote device including a remote resource collection component consistent with the present disclosure. For the clarity and ease of understanding, FIG. 6 depicts remote device 601 as including relatively few components, i.e., device platform 602, processor 603, and remote resource collection component 301. It should be understood that such representation is exemplary only, and that remote device may include any number of components. Indeed, remote device may be any type of device as defined above, and may include any or all of the components of such devices.

Processor 603 may be any type of processor, and may be configured to execute software 604. In this embodiment, software 604 includes remote resource identification module (RRIM) 605. Of course, software 604 may further include one or more operating systems, applications, combinations thereof, and the like (all not shown).

Generally, RRIM 605 is in the form of computer readable instructions that may be stored within a memory (not shown) of remote device 601. For example, RICM 506 may be stored on memory that is local to processor 603, and/or in another memory such as a memory within user interface circuitry or other circuitry. Such memory may one or more of the types of memory previously described above in connection with the storage of RICM 506.

It should therefore be understood RRIM 605 may be in the form of instructions stored in a computer readable medium, that when executed may cause remote device (or, more particular, processor 603) to perform remote resource collection operations consistent with the present disclosure. Such operations are consistent with the functions of remote resource collection component 301 discussed above in connection with FIGS. 3 and 4, and thus are not reiterated here.

Reference is now made to FIG. 7, which depicts a system level overview of an exemplary interactive augmented reality system consistent with the present disclosure and the potential communications between elements of such system. As shown, system 700 includes interaction device 101. As described previously, interaction device 101 may operate to detect objects in an environment, as well as the presence of resources associated with such objects, in this case controlled resource 110. Consistent with the foregoing description of FIGS. 1-4, interaction device 101 may directly or indirectly detect controlled resource 110. In former case, interaction device 101 may detect a resource for control (e.g., controlled resource 110) using a local resource identification component, as previously described in connection with FIGS. 1 and 2. In the latter case, interaction device 101 may learn of controlled resource from another source, such as optional remote device 601, optional server 702, or a combination thereof.

When used, optional remote device 601 and/or optional server 702 may communicate the presence or absence of controlled resource 110 to interactive device 101 based on information contained in one or more databases, i.e. databases 311 and/or 711. Such databases may include resource information indexed by a characteristic, such as location, identifier, room number, etc., as previously described. Alternatively or additionally, optional remote device 601 and/or server 702 may include one or more remote resource collection components that may be used to image an environment and convey environmental data signals which may identify or enable the identification of controlled resource 110 to/by interaction device 101, as previously described.

Interaction device 101, optional remote device 601, optional server 702, and controlled resource 110 may communicate directly or indirectly, as previously described. For example, communication between such elements may occur directly through the use of one or more short range communications protocols. Alternatively or additionally, communication between such elements may occur indirectly using long range communication protocol, e.g., over network 701. In this regard, network 701 may be any suitable network that carries data. As examples of suitable networks that may be used as network 701 in accordance with the present disclosure, mention is made of the internet, private networks, virtual private networks (VPN), public switch telephone networks (PSTN), integrated services digital networks (ISDN), digital subscriber link networks (DSL), wireless data networks (e.g., cellular phone networks), combinations thereof, and other networks capable of carrying data. In some non-limiting embodiments, network 701 includes at least one of the internet, an enterprise network, a wireless network, and a cellular telephone network.

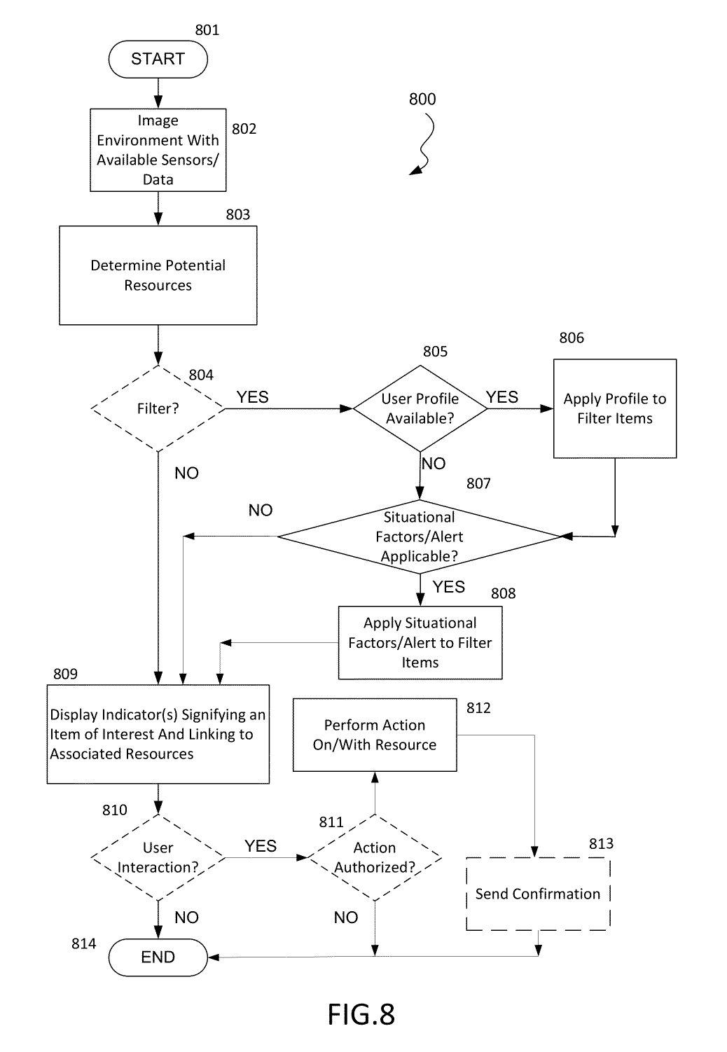

Another aspect of the present disclosure relates to methods for producing an interactive augmented reality with an interactive device. In this regard, reference is made to FIG. 8, which depicts an exemplary method consistent with the present disclosure.

As shown, method 800 begins at block 801. At block 802, an interactive device may image an environment using sensors and/or data that are available to it. For example, where the interactive device is equipped with one or more environmental sensors, it may use such sensors to image its environment, as previously described. Alternatively or additionally, the interaction device may communicate with one or more remote devices and/or servers, which may send information to the interaction device regarding an environment and/or resources contained therein.

Once the scan is complete, the method may proceed to block 803, wherein the interaction device may determine the existence of potential resources. Such resources may be available within the environment local to the interaction device, or they may be remote. The interaction device may determine the existence of potential resources by analyzing environmental signals produced during the scan performed in step 802. Alternatively or additionally, the interactive device may determine the presence of potential resource from communications received from a remote device and/or a server, as previously described.

At this point, the method may proceed to optional block 804, wherein the interactive device determines whether a filter is to be applied to the detected objects and/or resources. If no filter is to be applied, the method may proceed to block 809. But if a filter is to be applied, the method may proceed to block 805, wherein a determination is made as to whether an applicable user profile is available. If a user profile is available, the interactive device may apply the profile to filter the objects and resources detected and determined in blocks 802 and 803, as shown in block 806. Once user profile filtering is complete or if no user profile will be applied, the method may proceed to block 807.

At block 807, a determination may be made as to whether any applicable situational factors and/or alerts are available for filtering the detected objects and/or resources. If so, the method may proceed to block 808, wherein such situational factors and/or alerts are applied to filter the detected objects and/or resources. Once such filtering is complete or if no situational factors/alerts are to be applied, the method may proceed to block 809.

At block 809, the interactive device may display indicators signifying the presence of detected objects and linking to associated resources, as described above. The method may then proceed to block 810, wherein a determination may be made as to whether a user has interacted with any of the displayed indicators. If not, the method may proceed to block 814 and end. If so, the method may proceed to optional block 811, wherein the interaction device may determine whether the user is authorized to access and/or perform a desired action with the resources linked to the indicator in question. If the user is not authorized to access the resource or use it in the desired manner, the method may proceed to block 814 and end. If the user is authorized to access and use the resource in the desired manner, the method may proceed to block 812, wherein access is granted to the resource and the action desired by the user is performed. The method may then proceed to optional block 813, wherein the interactive device confirms that the action has been performed. The method may then proceed to block 814 and end.

Accordingly, one example of the present disclosure is an interaction device, including: a resource collection component configured to output an environmental signal including information about an object within an environment; a processor in communication with the resource collection component, the processor configured to receive and analyze the environmental signal to identify the object and correlate at least one resource with the object, the processor further configured to output an interface signal; and an interface component in communication with the processor and including an interface. The interface component is operable in response to receiving the interface signal to produce an indicator with the interface, wherein the indicator is operable in response to a user interaction to initiate a control protocol that enables at least one of modification and control of the resource with the interaction device.

Another exemplary interaction device includes any or all of the foregoing components, wherein the resource collection component includes at least one sensor that is operable to image the environment and obtain the information about the object.

Another exemplary interaction device includes any or all of the foregoing components, wherein the resource collection component is operable to receive the information about the object from a remote device.

Another exemplary interaction device includes any or all of the foregoing components, wherein the processor correlates the at least one resource with the object by querying at least one database.

Another exemplary interaction device includes any or all of the foregoing components, wherein the database is stored in a memory of the interaction device.

Another exemplary interaction device includes any or all of the foregoing components, wherein the database is stored in a memory of a remote device.

Another exemplary interaction device includes any or all of the foregoing components, wherein the interface component is chosen from a display, a lighting element, a button or a combination thereof.

Another exemplary interaction device includes any or all of the foregoing components, wherein the interface component: is a display; is operable to display an image of the object on the display; and is further operable to overlay the indicator on the image of the object, integrate the indicator with the image of the object, or a combination thereof.

Another exemplary interaction device includes any or all of the foregoing components, wherein the interface component renders the indicator as an outline of the image of the object.

Another exemplary interaction device includes any or all of the foregoing components, and further includes a filtering component, wherein the processor is operable to apply the filtering component to limit or emphasize the production of the indicator.

Another exemplary interaction device includes any or all of the foregoing components, wherein the filtering component includes a user profile, and the processor applies at least one parameter of the user profile to limit or emphasize the production of the indicator.

Another exemplary interaction device includes any or all of the foregoing components, wherein the control protocol includes a security protocol operative to permit an authorized user to access the resource, and to deny access to the resource to unauthorized users.

Another exemplary interaction device includes any or all of the foregoing components, wherein the resource is selected from the group consisting of use instructions for the object, repair instructions for the object, background information relevant to the object, audio/visual resources of or available through the object, computing resources of or available through the object, communications systems of or available through the object, an e-commerce system, an enterprise system, a database, an email system, a scheduling system, a telecommunication system, a computing network, a display, a speaker, lighting, and combinations thereof.

Another example of the present disclosure is a method, including: analyzing an environmental signal with a processor of an interaction device to identify at least one object in an environment; correlating with the processor the at least one object with at least one resource; and producing an indicator with an interface of the interaction device, the indicator signifying the correlation of the at least one object with the at least one resource, wherein the indicator is operable in response to a user interaction to initiate a control protocol that enables at least one of modification and control of the at least one resource with the interaction device.

Another exemplary method includes any or all of the foregoing elements, and further includes: imaging an environment with a resource collection component; and producing the environmental signal with the resource collection component.

Another exemplary method includes any or all of the foregoing elements, wherein a resource collection component is included in the interaction device, a remote device, or combination thereof.

Another exemplary method includes any or all of the foregoing elements, wherein the processor performs the correlating by querying at least one database.

Another exemplary method includes any or all of the foregoing elements, wherein the database is stored on at least one of the interaction device, a remote device, and a server.

Another exemplary method includes any or all of the foregoing elements, wherein the interface is chosen from a display, a lighting element, a button or a combination thereof.

Another exemplary method includes any or all of the foregoing elements, wherein the interface is a display, and the method further includes: displaying an image of the at least one object on the display; and the producing includes at least one of overlaying the indicator on the image and integrating the indicator with the image.

Another exemplary method includes any or all of the foregoing elements, wherein the producing includes rendering the indicator as an outline of the image of the at least one object.

Another exemplary method includes any or all of the foregoing elements, wherein the at least one object includes a plurality of objects and the at least one resource includes a plurality of resources, and the method further includes: identifying all or a portion of the plurality of objects with the processor; correlating with the processor all or a portion of the plurality of objects with one or more of the plurality of resources; applying a filtering component with the processor to identify at least one object of interest from the plurality of objects; producing with the interface an indicator for the at least one object of interest, the indicator signifying the correlation of the at least one object of interest with one or more of the plurality of resources, wherein the indicator is operable in response to a user interaction to initiate the control protocol, so as to enable at least one of modification and control of the at least one resource correlated to the object of interest with the interaction device.

Another exemplary method includes any or all of the foregoing elements, wherein the filtering component includes a user profile, and the processor applies at least one parameter of the user profile to identify the at least one object of interest from the plurality of objects.

Another exemplary method includes any or all of the foregoing elements, wherein the control protocol includes a security protocol operative to permit an authorized user to access the at least one resource, and to deny access to the resource to unauthorized users.

Another exemplary method includes any or all of the foregoing elements, wherein the at least one resource is selected from the group consisting of use instructions for the at least one object, repair instructions for the at least one object, background information relevant to the at least one object, audio/visual resources of or available through the at least one object, computing resources of or available through the at least one object, communications systems of or available through the at least one object, an e-commerce system, an enterprise system, a database, an email system, a scheduling system, a telecommunication system, a computing network, a display, a speaker, lighting, and combinations thereof.

Another example of the present disclosure relates to at least one computer readable medium. The at least one computer readable medium has resource identification and correlation module (RICM) instructions stored therein, wherein the RICM instructions when executed by a processor of an interaction device cause the interaction device to perform the following operations including: analyze an environmental signal with the processor to identify at least one object in an environment; correlate with the processor the at least one object with at least one resource; produce an indicator with an interface of the interaction device, the indicator signifying the correlation of the at least one object with the at least one resource, wherein the indicator is operable in response to a user interaction to initiate a control protocol that enables at least one of modification and control of the at least one resource with the interaction device.

Another exemplary at least one computer readable medium includes any or all of the foregoing components, wherein the RICM instructions when executed by the processor further cause the interaction device to perform the following operations including: image an environment with a resource collection component of the interaction device; and produce the environmental signal with the resource collection component.

Another exemplary at least one computer readable medium includes any or all of the foregoing components, wherein the RICM instructions when executed by the processor further cause the interaction device to perform the following operations including: receive the environmental signal from a remote resource collection component of a remote device.

Another exemplary at least one computer readable medium includes any or all of the foregoing components, wherein the processor performs the correlating by querying at least one database.

Another exemplary at least one computer readable medium includes any or all of the foregoing components, wherein the database is stored on at least one of the interaction device, a remote device, and a server.

Another exemplary at least one computer readable medium includes any or all of the foregoing components, wherein the interface is chosen from a display, a lighting element, a button or a combination thereof.

Another exemplary at least one computer readable medium includes any or all of the foregoing components, wherein the interface includes a display, and the RICM instructions when executed by the processor further cause the interaction device to perform the following operations including: display an image of the at least one object on the display; and produce the indicator by least one of overlaying the indicator on the image and integrating the indicator with the image.

Another exemplary at least one computer readable medium includes any or all of the foregoing components, wherein the RICM instructions when executed by the processor further cause the interaction device to perform the following operations including: render the indicator as an outline of the image of the at least one object.

Another exemplary at least one computer readable medium includes any or all of the foregoing components, wherein the at least one object includes a plurality of objects and the at least one resource includes a plurality of resources, the RICM instructions when executed by the processor further cause the interaction device to perform the following operations including: identify all or a portion of the plurality of objects with the processor; correlate with the processor all or a portion of the plurality of objects with one or more of the plurality of resources; apply a filtering component with the processor to identify at least one object of interest from the plurality of objects; produce with the interface an indicator for the at least one object of interest, the indicator signifying the correlation of the at least one object of interest with one or more of the plurality of resources, wherein the indicator is operable in response to a user interaction to initiate the control protocol, so as to enable at least one of modification and control of the at least one resource correlated to the object of interest with the interaction device.

Another exemplary at least one computer readable medium includes any or all of the foregoing components, wherein the filtering component includes a user profile, and the RICM instructions when executed by the processor further cause the interaction device to perform the following operations including: apply at least one parameter of the user profile to identify the at least one object of interest from the plurality of objects.

Another exemplary at least one computer readable medium includes any or all of the foregoing components, wherein the control protocol includes a security protocol, and the RICM instructions when executed by the processor further cause the interaction device to perform the following operations including: permit an authorized user to access the at least one resource; and deny access to the at least one resource to an unauthorized user.

Another exemplary at least one computer readable medium includes any or all of the foregoing components, wherein the at least one resource is selected from the group consisting of use instructions for the at least one object, repair instructions for the at least one object, background information relevant to the at least one object, audio/visual resources of or available through the at least one object, computing resources of or available through the at least one object, communications systems of or available through the at least one object, an e-commerce system, an enterprise system, a database, an email system, a scheduling system, a telecommunication system, a computing network, a display, a speaker, lighting, and combinations thereof.

As should be understood from the foregoing, the augmented reality technology described herein may provide a convenient mechanism to enable a person to identify objects of interest and interact with resources correlated to such objects. As such, the augmented reality technology described herein may enhance employee productivity, increase participation by meeting attendances, and/or provide one or more other benefits.

Other embodiments of the present disclosure will be apparent to those skilled in the art from consideration of the specification and practice of the inventions disclosed herein. It is intended that the specification be considered as exemplary only, and as illustrative of non-limiting embodiments of the invention as indicated by the following claims.

What is claimed is:

1. An interaction device, comprising:
a resource collection component configured to output an environmental signal comprising information about an object within an environment;
a processor in communication with said resource collection component, said processor configured to receive and analyze said environmental signal to identify said object and correlate at least one resource with said object, said processor further configured to output an interface signal; and
an interface component in communication with said processor and comprising an interface, said interface component operable in response to receiving said interface signal to produce an indicator with said interface, wherein said indicator is operable in response to a user interaction to initiate a control protocol that enables at least one of modification and control of said resource with said interaction device.

2. The interaction device of claim 1, wherein said resource collection component comprises at least one sensor, said sensor operable to image said environment and obtain said information about said object.

3. The interaction device of claim 1, wherein said processor correlates said at least one resource with said object by querying at least one database.

4. The interaction device of claim 3, wherein said database is stored in a memory of said interaction device, a memory of a remote device, or a combination thereof.

5. The interaction device of claim 1, wherein said interface component comprises a display, a lighting element, a button or a combination thereof.

6. The interaction device of claim 1, wherein said interface:
comprises a display;
is operable to display an image of said object on said display; and
is further operable to overlay said indicator on said image of said object, integrate said indicator with said image of said object, or a combination thereof.

7. The interaction device of claim 1, further comprising a filtering component, wherein said processor is operable to apply said filtering component to limit or emphasize the production of said indicator.

8. The interaction device of claim 7, wherein said filtering component comprises a user profile, wherein said processor applies at least one parameter of said user profile to limit or emphasize the production of said indicator.

9. The interaction device of claim 1, wherein said control protocol comprises a security protocol operative to permit an authorized user to access said resource, and to deny access to said resource to unauthorized users.

10. The interaction device of claim 1, wherein said resource is selected from the group consisting of use instructions for said object, repair instructions for said object, background information relevant to said object, audio/visual resources of or available through said object, computing resources of or available through said object, communications systems of or available through said object, an e-commerce system, an enterprise system, a database, an email system, a scheduling system, a telecommunication system, a computing network, a display, a speaker, lighting, and combinations thereof.

11. A method, comprising:
analyzing an environmental signal with a processor of an interaction device to identify at least one object in an environment;
correlating with said processor said at least one object with at least one resource; and
producing an indicator with an interface of said interaction device, said indicator signifying said correlation of said at least one object with said at least one resource, wherein said indicator is operable in response to a user interaction to initiate a control protocol that enables at least one of modification and control of said at least one resource with said interaction device.

12. The method of claim 11, further comprising:
imaging an environment with a resource collection component; and
producing said environmental signal with said resource collection component.

13. The method of claim 12, wherein resource collection component is included in said interaction device, a remote device, or combination thereof.

14. The method of claim 11, wherein said processor performs said correlating by querying at least one database.

15. The method of claim 14, wherein said database is stored on at least one of said interaction device, a remote device, and a server.

16. The method of claim 11, wherein said interface is a display, said method further comprising:
displaying an image of said at least one object on said display; and
said producing comprises at least one of overlaying said indicator on said image and integrating said indicator with said image.

17. The method of claim 11, wherein said at least one object comprises a plurality of objects and said at least one resource comprises a plurality of resources, the method further comprising:
identifying all or a portion of said plurality of objects with said processor;
correlating with said processor all or a portion of said plurality of objects with one or more of said plurality of resources;
applying a filtering component with said processor to identify at least one object of interest from said plurality of objects;
producing with said interface an indicator for said at least one object of interest, said indicator signifying said correlation of said at least one object of interest with one or more of said plurality of resources, wherein said indicator is operable in response to a user interaction to initiate said control protocol, so as to enable at least one of modification and control of said at least one resource correlated to said object of interest with said interaction device.

18. The method of claim 17, wherein said filtering component comprises a user profile, and said processor applies at least one parameter of said user profile to identify said at least one object of interest from said plurality of objects.

19. The method of claim 11, wherein said control protocol comprises a security protocol operative to permit an authorized user to access said at least one resource, and to deny access to said resource to unauthorized users.

20. The method of claim 11, wherein said at least one resource is selected from the group consisting of use instructions for said at least one object, repair instructions for said at least one object, background information relevant to said at least one object, audio/visual resources of or available through said at least one object, computing resources of or available through said at least one object, communications systems of or available through said at least one object, an e-commerce system, an enterprise system, a database, an email system, a scheduling system, a telecommunication system, a computing network, a display, a speaker, lighting, and combinations thereof.

21. At least one computer readable medium having resource identification and correlation module (RICM) instructions stored therein, wherein said RICM instructions when executed by a processor of an interaction device cause said interaction device to perform the following operations comprising:
analyze an environmental signal with said processor to identify at least one object in an environment;
correlate with said processor said at least one object with at least one resource;
produce an indicator with an interface of said interaction device, said indicator signifying said correlation of said at least one object with said at least one resource, wherein said indicator is operable in response to a user interaction to initiate a control protocol that enables at least one of modification and control of said at least one resource with said interaction device.

22. The at least one computer readable medium of claim 21, wherein said RICM instructions when executed by said processor further cause said interaction device to perform the following operations comprising:
image an environment with a resource collection component of said interaction device; and
produce said environmental signal with said resource collection component.

23. The at least one computer readable medium of claim 21, wherein said RICM instructions when executed by said processor further cause said interaction device to perform the following operations comprising:
receive said environmental signal from a remote resource collection component of a remote device.

24. The at least one computer readable medium of claim 21, wherein said processor performs said correlating by querying at least one database.

25. The at least one computer readable medium of claim 24, wherein said database is stored on at least one of said interaction device, a remote device, and a server.

26. The at least one computer readable medium of claim 21, wherein said interface comprises a display, and said RICM instructions when executed by said processor further cause said interaction device to perform the following operations comprising:
display an image of said at least one object on said display; and
produce said indicator by least one of overlaying said indicator on said image and integrating said indicator with said image.

27. The at least one computer readable medium of claim 26, wherein said RICM instructions when executed by said processor further cause said interaction device to perform the following operations comprising:
render said indicator as an outline of said image of said at least one object.

28. The at least one computer readable medium of claim 21, wherein said at least one object comprises a plurality of objects and said at least one resource comprises a plurality of resources, said RICM instructions when executed by said processor further cause said interaction device to perform the following operations comprising:
identify all or a portion of said plurality of objects with said processor;
correlate with said processor all or a portion of said plurality of objects with one or more of said plurality of resources;
apply a filtering component with said processor to identify at least one object of interest from said plurality of objects;
produce with said interface an indicator for said at least one object of interest, said indicator signifying said correlation of said at least one object of interest with one or more of said plurality of resources, wherein said indicator is operable in response to a user interaction to initiate said control protocol, so as to enable at least one of modification and control of said at least one resource correlated to said object of interest with said interaction device.

29. The at least one computer readable medium of claim 28, wherein said filtering component comprises a user profile, and said RICM instructions when executed by said processor further cause said interaction device to perform the following operations comprising:
apply at least one parameter of said user profile to identify said at least one object of interest from said plurality of objects.

30. The at least one computer readable medium of claim 21, wherein said control protocol comprises a security protocol, and said RICM instructions when executed by said processor further cause said interaction device to perform the following operations comprising:
permit an authorized user to access said at least one resource; and
deny access to said at least one resource to an unauthorized user.
